(19) United States
(12) Patent Application Publication
(10) Pub. No.: US 2007/0100091 A1
(43) Pub. Date: May 3, 2007

(54) Crosslinked poly(arylene ether) composition, method, and article

(76) Inventors: Anantharaman Dhanabalan, Bangalore (IN); Abhijit Som, Bangalore (IN)

Correspondence Address: CANTOR COLBURN, LLP, 55 GRIFFIN ROAD SOUTH, BLOOMFIELD, CT, 06002, US

(21) Appl. No.: 11/263,248

(22) Filed: Oct. 31, 2005

(51) Int. Cl. C08G 8/28

(52) U.S. Cl. 525/480

(57) ABSTRACT

A poly(arylene ether) may be reacted with a formaldehyde compound in the presence of trifluoroacetic acid to form a crosslinked poly(arylene ether). The crosslinked poly(arylene ether) has excellent heat resistance, solvent resistance, and dielectric properties, and it is useful in the fabrication of electronic devices.

### BACKGROUND OF THE INVENTION

Poly(arylene ether) resins are known materials with excellent physical and dielectric properties that make them suitable for a wide variety of product applications. One approach to improving the solvent resistance and heat resistance of poly(arylene ether) resins, particularly for use in electronic materials, has been to functionalize them with polymerizable functional groups that allow them to react (crosslink) with themselves and with other comonomers. For example, U.S. Pat. No. 4,923,932 to Katayose et al. describes the preparation of poly(arylene ether) resins functionalized with pendant allyl groups throughout the poly(arylene ether) chain. As another example, U.S. Pat. No. 5,091,480 to Percec and U.S. Statutory Invention Registration H521 to Fan describe the preparation of poly(arylene ether) molecules terminally functionalized with carbon-carbon double bonds. Although the functionalized poly(arylene ether) molecules may be reacted to form materials with improved solvent resistance and heat resistance, multiple synthesis, isolation, compounding, and processing steps are required to reach the ultimate crosslinked materials. There is therefore a desire for a simpler approached to crosslinked poly(arylene ether) compositions.

### BRIEF DESCRIPTION OF THE INVENTION

The above-described and other drawbacks are alleviated by a method of preparing a crosslinked poly(arylene ether), comprising reacting an uncrosslinked poly(arylene ether) with a formaldehyde compound in the presence of a catalytically effective amount of trifluoroacetic acid.

Other embodiments, including the crosslinked poly(arylene ether) itself, compositions comprising the crosslinked poly(arylene ether), and articles comprising the crosslinked poly(arylene ether)-containing composition, are described in detail below.

### DETAILED DESCRIPTION OF THE INVENTION

One embodiment is a method of preparing a crosslinked poly(arylene ether), comprising reacting an uncrosslinked poly(arylene ether) with a formaldehyde compound in the presence of a catalytically effective amount of trifluoroacetic acid. The present inventors have discovered that an uncrosslinked poly(arylene ether) comprising arylene ether units with at least one aryl hydrogen may be crosslinked with a formaldehyde compound in the presence of trifluoroacetic acid to form a poly(arylene ether) crosslinked by methylene units that bridge the arylene rings of different poly(arylene ether) chains.

The uncrosslinked poly(arylene ether) starting material may comprise a plurality of structural units of the formula 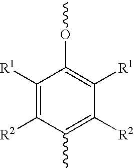
wherein each occurrence of R¹ is independently halogen, primary or secondary C₁-C₈ alkyl, phenyl, C₁-C₈ haloalkyl, C₁-C₈ aminoalkyl, C₁-C₈ hydrocarbonoxy, or C₂-C₈ halohydrocarbonoxy wherein at least two carbon atoms separate the halogen and oxygen atoms; and each occurrence of R² is independently hydrogen, halogen, primary or secondary C₁-C₈ alkyl, phenyl, C₁-C₈ haloalkyl, C₁-C₈ aminoalkyl, C₁-C₈ hydrocarbonoxy, or C₂-C₈ halohydrocarbonoxy wherein at least two carbon atoms separate the halogen and oxygen atoms, with the proviso that at least one occurrence of R² is hydrogen. In one embodiment, each occurrence of R¹ is methyl, and each occurrence of R² is hydrogen or methyl. In the structure above, the wavy lines indicate single bonds to adjacent structural units.

The uncrosslinked poly(arylene ether) is typically prepared by the oxidative coupling of at least one monohydroxyaromatic compound having the structure 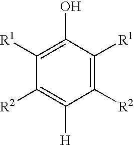
wherein R¹ and R² are as defined as above for the uncrosslinked poly(arylene ether). Suitable monohydroxyaromatic compounds include, for example, 2,6-xylenol and 2,3,6-trimethylphenol. Catalyst systems are generally employed for such oxidative coupling. They typically comprise at least one heavy metal compound such as a copper, manganese or cobalt compound, usually in combination with various other catalyst components.

There is no particular limitation on the intrinsic viscosity of the poly(arylene ether). In one embodiment, the poly(arylene ether) has an intrinsic viscosity of about 0.05 to about 1.0 deciliter per gram, measured at 25° C. in chloroform. Within this range, the intrinsic viscosity may be at least about 0.1 deciliter per gram, or at least about 0.2 deciliter per gram. Also within this range, the intrinsic viscosity may be up to about 0.8 deciliter per gram, or up to about 0.6 deciliter per gram. In one embodiment, the poly(arylene ether) has an intrinsic viscosity of about 0.2 to about 0.6 deciliter per gram.

As used herein, the term “formaldehyde compound” includes formaldehyde (i.e., CH₂O), formaldehyde oligomers, and formaldehyde polymers. Formaldehyde oligomers include, for example, the cyclic trimer trioxane. Polymers of formaldehyde are generally called “polyacetals” and comprise a linear polymer chain containing recurring —CH₂O— units. A preferred polymer of formaldehyde is polyoxymethylene that has not been stabilized against thermal degradation as, for example, by end-capping the ends of the linear polymer chain with stabilizing end-groups. Thus, a preferred polymer of formaldehyde is paraformaldehyde, which is a lower molecular weight (e.g., about 10 to about 50 —CH₂O— units per polymer chain, on average) linear polymer available commercially as pellets or a fine powder. Other polymers of formaldehyde that can be utilized herein are described generally in U.S. Pat. No. 2,768,994 to MacDonald. Another variety of formaldehyde polymers is sold under the registered trademark Delrin® acetal resins by E. I. du Pont de Nemours and Company, Inc. Delrin® acetal resin polymers are usually stabilized against thermal degradation but may still be utilized.

The formaldehyde compound may be used at a concentration sufficient to provide adequate crosslinking at a reasonable reaction rate. For example, the poly(arylene ether) and the formaldehyde compound may be present in amounts such that the mole ratio of formaldehyde equivalents in the formaldehyde compound (i.e., CH₂O equivalents) to arylene ether units in the uncrosslinked poly(arylene ether) is about 0.05 to about 2. Within this range, the ratio may be at least about 0.1, or at least about 0.2. Also within this range, the ratio may be up to about 1, or up to about 0.7.

The trifluoroacetic acid may be used in an amount effective to catalyze the crosslinking reaction. The present inventors have observed that high concentrations trifluoroacetic acid may also provide a beneficial solvent effect that helps dissolve formaldehyde polymers. It may therefore be advantageous to use a trifluoroacetic acid concentration that is larger than that normally expected to be required for acid catalysis. For example, the trifluoroacetic acid may be present in an amount such that a mole ratio of trifluoroacetic acid to formaldehyde equivalents in the formaldehyde compound is about 0.1 to about 30. Within this range, the ratio may be at least about 0.5, or at least about 1. Also within this range, the ratio may be up to about 20, or up to about 15. When the reaction is conducted in a solvent, the amount of the trifluoroacetic acid may, alternatively, be expressed as a volume/volume percent relative to the total volume of trifluoroacetic acid and solvent. Thus, the trifluoroacetic acid amount may be about 1 to about 50 volume/volume percent, based on the total volume of trifluoroacetic acid and solvent.

In one embodiment, reacting the uncrosslinked poly(arylene ether) with a formaldehyde compound is conducted in a solvent. Suitable solvents include halogenated alkanes such as dichloromethane (methylene chloride), trichloromethane (chloroform), tetrachloromethane (carbon tetrachloride), 1,2-dichloroethane, and the like; halogenated alkenes such as dichloroethylenes, trichloroethylene, and the like; and aromatic hydrocarbons such as benzene, toluene, xylenes, chlorobenzene, dichlorobenzenes, and the like; and mixtures thereof

The reaction between the uncrosslinked poly(arylene ether) and the formaldehyde compound may be conducted over a fairly wide temperature range. For example, the reaction may be conducted at a temperature of about 0 to about 140° C. Within this range, the temperature may be at least about 10° C., or at least about 20° C. Also within this range, the temperature may be up to about 100° C., or up to about 80° C. The selection of a reaction temperature may depend on the solvent used, if any, and the desired reaction rate, among other factors.

In addition to performing the reaction of poly(arylene ether) with a formaldehyde compound in a solvent, it is also possible to perform the reaction under melt conditions (i.e., under conditions in which the reaction temperature is above the glass transition temperature of the uncrosslinked poly(arylene ether)). However, this approach is not presently favored because the high temperature required to melt the poly(arylene ether) may degrade the formaldehyde compound, and because the trifluoroacetic acid may corrode the melt processing equipment.

Preparation of the crosslinked poly(arylene ether) may, optionally, include purifying and isolating steps. Thus, in one embodiment, the method comprises washing the crosslinked poly(arylene ether) with a solvent for the uncrosslinked poly(arylene ether). A solvent for the uncrosslinked poly(arylene ether) is a solvent in which the uncrosslinked poly(arylene ether) has a solubility of at least 10 grams per liter, preferably at least 100 grams per liter. Suitable solvents include, for example, aromatic solvents such as benzene, toluene, ethylbenzene, xylenes, o-dichlorobenzene, and the like; halogenated alkanes such as dichloromethane (methylene chloride), trichloromethane (chloroform), tetrachloromethane (carbon tetrachloride), 1,2-dichloroethane, and the like; halogenated alkenes such as dichloroethylenes, trichloroethylene, and the like; and mixtures thereof.

In one embodiment, the method comprises washing the crosslinked poly(arylene ether) with an antisolvent for the uncrosslinked poly(arylene ether). An antisolvent for the uncrosslinked poly(arylene ether) is a solvent in which the uncrosslinked poly(arylene ether) has a solubility of less than 10 grams per liter, preferably less than 1 gram per liter, more preferably less than 0.5 gram per liter. Suitable antisolvents include, for example, lower alkanols having one to about ten carbon atoms, such as methanol, ethanol, isopropanol, and the like; ketones having three to about ten carbon atoms, such as acetone, methyl ethyl ketone, and the like; and alkanes having about five to about ten carbon atoms, such as hexanes, heptanes, and the like; and combinations thereof Such solvents often function not only as antisolvents for the uncrosslinked poly(arylene ether), but also as solvents for the formaldehyde compound and the trifluoroacetic acid.

The method may, optionally, further comprise drying the crosslinked poly(arylene ether) to remove residual solvents, reagents, or byproducts. Suitable drying conditions include a temperature of about 50 to about 150° C. for about 5 minutes to about 2 days. Within the drying temperature range above, the temperature may be at least about 65° C., or at least about 80° C. Also within the drying temperature range above, the temperature may be up to about 135° C., or up to about 120° C. Within the drying time range above, the time may be at least about 20 minutes. Also within the drying time range above, the time may be up to about 1 day. Drying may, optionally, be conducted under vacuum.

In one embodiment, reacting the uncrosslinked poly(arylene ether) with a formaldehyde compound is conducted in the absence of any hydrohalic acid. For example, the method is distinguished from reactions in which a poly(arylene ether) is reacted with paraformaldehyde and hydrochloric acid or hydrobromic acid to generate a halomethyl-substituted poly(arylene ether).

In another embodiment, reacting the uncrosslinked poly(arylene ether) with a formaldehyde compound is conducted in the absence of any polymer other than the uncrosslinked poly(arylene ether). For example, the method is distinguished from reactions in which a formaldehyde compound is used to compatibilize blends of poly(arylene ether) resins with polyamides or poly(phenylene sulfide) resins.

One embodiment is a method of preparing a crosslinked poly(arylene ether), comprising: reacting an uncrosslinked poly(arylene ether) with paraformaldehyde in the presence of a solvent and a catalytically effective amount of trifluoroacetic acid to form a crosslinked poly(arylene ether); wherein the uncrosslinked poly(arylene ether) is a poly(2,6-dimethyl-1,4-phenylene ether) or a poly(2,6-dimethyl-1,4-phenylene ether-co-2,3,6-trimethyl-1,4-phenylene ether); wherein the solvent is selected from chloroform or 1,2-dichloroethane; wherein the poly(arylene ether) and the paraformaldehyde are present in amounts such that a mole ratio of formaldehyde equivalents in the paraformaldehyde to arylene ether units in the uncrosslinked poly(arylene ether) is about 0.1 to about 1; and wherein the trifluoroacetic acid is present in an amount such that a mole ratio of trifluoroacetic acid to formaldehyde equivalents in the paraformaldehyde is about 0.5 to about 20; washing the crosslinked poly(arylene ether) with an antisolvent for the uncrosslinked poly(arylene ether); and drying the crosslinked poly(arylene ether) at about 65 to about 135° C. for about 20 minutes to about 1 day.

One embodiment is a poly(arylene ether) prepared according to any of the above-described methods.

Thus, one embodiment is a crosslinked poly(arylene ether), comprising about 0.1 to about 50 weight percent of crosslinked units having the structure 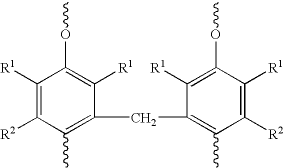
wherein each occurrence of R¹ is independently halogen, primary or secondary C₁-C₈ alkyl, phenyl, C₁-C₈ haloalkyl, C₁-C₈ aminoalkyl, C₁-C₈ hydrocarbonoxy, or C₂-C₈ halohydrocarbonoxy wherein at least two carbon atoms separate the halogen and oxygen atoms; and each occurrence of R² is independently hydrogen, halogen, primary or secondary C₁-C₈ alkyl, phenyl, C₁-C₈ haloalkyl, C₁-C₈ aminoalkyl, C₁-C₈ hydrocarbonoxy, or C₂-C₈ halohydrocarbonoxy wherein at least two carbon atoms separate the halogen and oxygen atoms. In the structure above, it will be understood that the wavy lines indicate that the adjacent atom of the crosslinked unit shown is bonded to an atom of another subunit of the crosslinked poly(arylene ether). In one embodiment, each R¹ is methyl and each R² is hydrogen or methyl. In another embodiment, each R¹ is methyl and each R² is hydrogen.

One embodiment is a crosslinked poly(arylene ether), comprising: about 50 to about 99.8 weight percent of internal uncrosslinked units having the structure 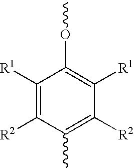
wherein each occurrence of R¹ is independently halogen, primary or secondary C₁-C₈ alkyl, phenyl, C₁-C₈ haloalkyl, C₁-C₈ aminoalkyl, C₁-C₈ hydrocarbonoxy, or C₂-C₈ halohydrocarbonoxy wherein at least two carbon atoms separate the halogen and oxygen atoms; and each occurrence of R² is independently hydrogen, halogen, primary or secondary C₁-C₈ alkyl, phenyl, C₁-C₈ haloalkyl, C₁-C₈ aminoalkyl, C₁-C₈ hydrocarbonoxy, or C₂-C₈ halohydrocarbonoxy wherein at least two carbon atoms separate the halogen and oxygen atoms, with the proviso that at least one occurrence of R² is hydrogen; about 0.1 to about 10 weight percent of terminal uncrosslinked units having a structure selected from 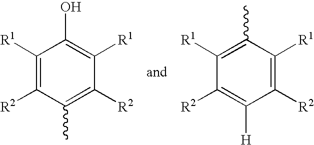
wherein each occurrence of R¹ is independently halogen, primary or secondary C₁-C₈ alkyl, phenyl, C₁-C₈ haloalkyl, C₁-C₈ aminoalkyl, C₁-C₈ hydrocarbonoxy, or C₂-C₈ halohydrocarbonoxy wherein at least two carbon atoms separate the halogen and oxygen atoms; and each occurrence of R² is independently hydrogen, halogen, primary or secondary C₁-C₈ alkyl, phenyl, C₁-C₈ haloalkyl, C₁-C₈ aminoalkyl, C₁-C₈ hydrocarbonoxy, or C₂-C₈ halohydrocarbonoxy wherein at least two carbon atoms separate the halogen and oxygen atoms, with the proviso that at least one occurrence of R² is hydrogen; and about 0.1 to about 50 weight percent of crosslinked units having a structure selected from 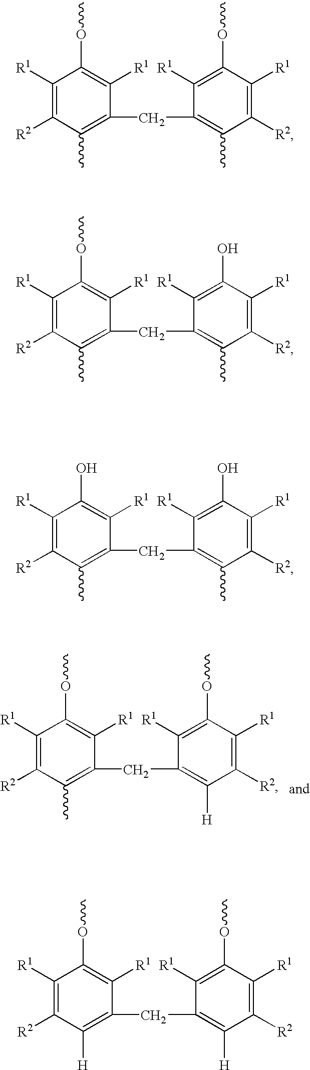
wherein each occurrence of R¹ is independently halogen, primary or secondary C₁-C₈ alkyl, phenyl, C₁-C₈ haloalkyl, C₁-C₈ aminoalkyl, C₁-C₈ hydrocarbonoxy, or C₂-C₈ halohydrocarbonoxy wherein at least two carbon atoms separate the halogen and oxygen atoms; and each occurrence of R² is independently hydrogen, halogen, primary or secondary C₁-C₈ alkyl, phenyl, C₁-C₈ haloalkyl, C₁-C₈ aminoalkyl, C₁-C₈ hydrocarbonoxy, or C₂-C₈ halohydrocarbonoxy wherein at least two carbon atoms separate the halogen and oxygen atoms. In one embodiment, each occurrence of R¹ is methyl, and each occurrence of R² is hydrogen or methyl. In another embodiment, each occurrence of R¹ is methyl and each occurrence of R² is hydrogen.

The crosslinked poly(arylene ether) exhibits various desirable properties. For example, the crosslinked poly(arylene ether) may exhibit a glass transition temperature of about 170 to about 290° C. As another example, the crosslinked poly(arylene ether) may exhibit a solubility in chloroform at 25° C. of about 0.1 to about 20 milligrams per milliliter.

One embodiment is a composition comprising any of the crosslinked poly(arylene ether) resins described above. In one embodiment, the composition comprises at least 50 weight percent of the crosslinked poly(arylene ether), or at least 80 weight percent of the crosslinked poly(arylene ether), or at least 90 weight percent of the crosslinked poly(arylene ether), or at least 95 weight percent of the crosslinked poly(arylene ether).

In addition to the crosslinked poly(arylene ether), the composition may, optionally, further comprise a poly(alkenyl aromatic) resin, a poly(dimethylsiloxane), or a combination thereof. The term “poly(alkenyl aromatic) resin” as used herein includes polymers prepared by methods known in the art including bulk, suspension, and emulsion polymerization, which contain at least 25% by weight of structural units derived from an alkenyl aromatic monomer of the formula 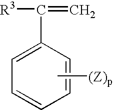
wherein R³ is hydrogen, C₁-C₈ alkyl, halogen, or the like; Z is vinyl, halogen, C₁-C₈ alkyl, or the like; and p is 0, 1, 2, 3, 4, or 5. Preferred alkenyl aromatic monomers include styrene, chlorostyrenes such as p-chlorostyrene, and methylstyrenes such as p-methylstyrene. The poly(alkenyl aromatic) resins include homopolymers of an alkenyl aromatic monomer; random copolymers of an alkenyl aromatic monomer, such as styrene, with one or more different monomers such as acrylonitrile, butadiene, alpha-methylstyrene, ethylvinylbenzene, divinylbenzene and maleic anhydride; and rubber-modified poly(alkenyl aromatic) resins comprising blends and/or grafts of a rubber modifier and a homopolymer of an alkenyl aromatic monomer (as described above), wherein the rubber modifier may be a polymerization product of at least one C₄-C₁₀ nonaromatic diene monomer, such as butadiene or isoprene. The term “poly(dimethylsiloxane)” as used herein refers to polymers comprising at least 80 weight percent of repeating units having the structure 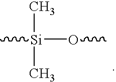
In one embodiment, the poly(dimethylsiloxane) comprises at least 90 weight percent of such repeating units. In one embodiment, the poly(dimethylsiloxane) has the structure 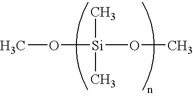
wherein n has an average value of about 20 to about 10,000.

In addition to the crosslinked poly(arylene ether), the composition may, optionally, further comprise one or more additives for thermoplastic or thermoset resins. Such additives include, for example, flame retardants, colorants, (including dyes and pigments), fillers (including inorganic fillers), polymeric additives, and mixtures thereof. Suitable polymeric additives include, for example, conducting polymers, light emitting polymers, dendrimers, amphiphilic polymers, block copolymers, polycarbonates, polyesters, polyamides, polyimides, polyetherimides, polysulfones, polyphenylene sulfides, polyethylene oxides, polypropylene oxides, polyvinyl chlorides, polybutadienes, polyisobutylenes, and the like, and combinations thereof.

One embodiment is an article or portion of an article comprising one of the above-described compositions. For example, the composition may be used to form a film, sheet, molded object or composite having at least one layer comprising the composition. Techniques suitable for forming articles comprising the composition include, for example, solvent casting. The composition is particularly suitable for use in electronic packaging materials and other dielectric components of electronic devices.

The invention is further illustrated by the following non-limiting examples.

### EXAMPLE 1

This example describes one procedure for preparing a crosslinked poly(arylene ether). Poly(2,6-dimethyl-1,4-phenylene ether) (4 grams; intrinsic viscosity=0.46 gram per deciliter; obtained from General Electric Company) was dissolved in chloroform (40 milliliters) in a beaker. Paraformaldehyde (400 milligrams, 40 mole percent based on moles of phenylene ether repeat units in the poly(2,6-dimethyl-1,4-phenylene ether)) was added. Trifluoroacetic acid (5 milliliters, 200 mole percent based on phenylene ether repeat units) was added, and the mixture was warmed to 60° C. in a water bath and swirled occasionally. The reaction mixture, which was initially light yellow, turned wine red. After about nine minutes, the solution gelled into a monolith.

To isolate the crosslinked product, methanol (100 milliliters) was added, and the monolith was broken into small bits with a stirring rod to facilitate mixing with the methanol. After waiting about six hours, solvent was decanted and the residual solid was washed twice with methanol (100 milliliters), and dried in a hot air oven at 100° C. for two days. Some solubles (ca. 2-6 weight percent) could be extracted from the crude product thus obtained by swelling the solid in chloroform, decanting, and washing again with methanol, but this extraction did not substantially change the thermal properties of the material.

### EXAMPLE 2

The example describes another procedure for preparing a crosslinked poly(arylene ether). Poly(2,6-dimethyl-1,4-phenylene ether) (4 grams; intrinsic viscosity=0.46 gram per deciliter; obtained from General Electric Company) was dissolved in chloroform (30 milliliters) in a beaker. Paraformaldehyde (400 milligrams, 40 mole percent based on phenylene ether repeat units) was dissolved in trifluoroacetic acid (5 milliliters, 200 mole percent based on phenylene ether repeat units) and chloroform (10 milliliters) in a separate vessel. The paraformaldehyde-trifluoroacetic acid mixture was added to the poly(arylene ether) solution, and the mixture was swirled occasionally at room temperature. The reaction mixture, which was initially light yellow, turned wine red. After about thirty minutes, the solution gelled into a monolith.

The isolation procedure of Example 1 was employed.

### EXAMPLE 3

The example describes another procedure for preparing a crosslinked poly(arylene ether). Poly(2,6-dimethyl-1,4-phenylene ether) (4 grams; intrinsic viscosity=0.46 gram per deciliter; obtained from General Electric Company) was dissolved in 1,2-dichloroethane (40 milliliters) in a beaker. Paraformaldehyde (400 milligrams, 40 mole percent based on phenylene ether repeat units) was added. Trifluoroacetic acid (5 milliliters, 200 mole percent based on phenylene ether repeat units) and was added and the resulting mixture was swirled occasionally at room temperature. The reaction mixture, which was initially light yellow, turned light orange. After about three minutes, the solution gelled into a monolith.

The isolation procedure of Example 1 was employed.

### EXAMPLE 4

This example describes the monitoring of the crosslinking reaction by proton nuclear magnetic resonance spectroscopy (¹H NMR). Poly(2,6-dimethyl-1,4-phenylene ether) (4 grams; intrinsic viscosity=0.46 gram per deciliter; obtained from General Electric Company) was dissolved in a mixture of chloroform (40milliliters) and trifluoroacetic acid (5 milliliters, 11.1 volume/volume percent) in a beaker. Paraformaldehyde (400 milligrams, 40 mole percent based on phenylene ether repeat units) was added. At intervals of 10, 20, 30 and 35 minutes 5 milliliter aliquots were pipetted out and poured in methanol to produce a white precipitate. At 35 minutes, the reaction mixture gelled. Precipitated aliquots corresponding to reaction times of 10, 20, 30, and 35 minutes were washed with more methanol, dried in a hot air oven at 80° C. for 24 hours, and analyzed by ¹H NMR and gel permeation chromatography

To obtain ¹H NMR spectra, deuterated chloroform was added the dried samples. Aliquots of 30 and 35 minutes were partially gelled. The remainder of the reaction mixture allowed to react for two hours, then quenched by methanol, washed, and dried in a hot air oven as described above. The sample was analyzed for gel content. Gel content was determined by swelling a weighed amount of sample in chloroform for 24 hours. The swelled mass was dried in a hot air oven and the final weight was noted. The percent gel content was calculated as the final weight divided by the initial weight times 100. The sample was determined to have a gel content of 98 percent.

Results are presented in Table 1. “Mw” is the weight average molecular weight, expressed in atomic mass units (AMU), and “PDI” is the polydispersity index (i.e., the ratio of weight average molecular weight to number average molecular weight), each as determined by GPC of the soluble fractions using polystryrene standards. “¹H NMR I_{b}/Iₐᵣ” is the ratio of intensities of the benzyl peak (i.e., the peak attributable to the hydrogen atoms of methylene groups bridging the phenylene groups of two different phenylene ether units) and the aryl peak (i.e., the peak attributable to hydrogen atoms directly bound to the 3 and 5 positions of the 2,6-dimethyl-1,4-phenylene ether units). The ratio of intensities of benzylic and aryl protons, I_{b}/Iₐᵣ, can be used to calculate the fraction of crosslinked phenylene ether units. For example, when I_{b}/Iₐᵣ, =0.049, then the fraction of crosslinked phenylene ether units is 0.049/(1+0.049)=0.047. The results show that the weight average molecular weight of soluble poly(arylene ether) increased with time until the mixture began to gel. The ¹H NMR results also show direct evidence of the methylene bridge between phenylene ether units formed by the paraformaldehyde crosslinking reaction.

TABLE 1

| Reaction Time | | | |
|---|---|---|---|
| (minutes) | M_{w} (AMU)* | PDI | ¹H NMR I_{b}/Iₐᵣ |
| 0 | 42,000 | 2.4 | — |
| 10 | 67,000 | 2.7 | 0.021 |
| 20 | 117,000 | 4.0 | 0.043 |
| 30 | 61,000 | 2.9 | 0.035 |
| 35 | 47,000 | 2.7 | 0.049 |

*CHCl₃ soluble portions

### COMPARATIVE EXAMPLES 1-5

These comparative examples illustrate that the crosslinking of poly(arylene ether) with paraformaldehyde does not readily occur in the presence of five acids other than trifluoroacetic acid: acetic acid, formic acid, trichloroacetic acid, chlorosulfonic acid, and sulfuric acid. The procedure of Example 2 was followed, except that other acids were substituted, equivolume, for trifluoroacetic acid. Results are presented in Table 2. The results showed that none of the other acids were effective to catalyze poly(arylene ether) crosslinking by paraformaldehyde. They either failed to dissolve the paraformaldehyde (C. Exs. 1-3), or they promoted crosslinking but also charred the resulting crosslinked polymer (C. Exs. 4 and 5).

TABLE 2

| C. Ex. | | |
|---|---|---|
| No. | Acid | Observation |
| 1 | acetic acid | no gelation; paraformaldehyde did not |
| | | dissolve |
| 2 | formic acid | no gelation; paraformaldehyde did not |
| | | dissolve |
| 3 | trichloroacetic acid | no gelation; paraformaldehyde did |
| | | not dissolve |
| 4 | chlorosulfonic acid | rapid gelation with charring |
| 5 | sulfuric acid | rapid gelation with charring |

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

All cited patents, patent applications, and other references are incorporated herein by reference in their entirety.

All ranges disclosed herein are inclusive of the endpoints, and the endpoints are combinable with each other.

The use of the terms “a” and “an” and “the” and similar referents in the context of describing the invention (especially in the context of the following claims) are to be construed to cover both the singular and the plural, unless otherwise indicated herein or clearly contradicted by context. Further, it should further be noted that the terms “first,” “second,” and the like herein do not denote any order, quantity, or importance, but rather are used to distinguish one element from another.

1. A crosslinked poly(arylene ether), comprising about 0.1 to about 50 weight percent of crosslinked units having the structure 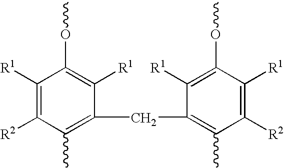
wherein each occurrence of R¹ is independently halogen, primary or secondary C₁-C₈ alkyl, phenyl, C₁-C₈ haloalkyl, C₁-C₈ aminoalkyl, C₁-C₈ hydrocarbonoxy, or C₂-C₈ halohydrocarbonoxy wherein at least two carbon atoms separate the halogen and oxygen atoms; and each occurrence of R² is independently hydrogen, halogen, primary or secondary C₁-C₈ alkyl, phenyl, C₁-C₈ haloalkyl, C₁-C₈ aminoalkyl, C₁-C₈ hydrocarbonoxy, or C₂-C₈ halohydrocarbonoxy wherein at least two carbon atoms separate the halogen and oxygen atoms.

2. The crosslinked poly(arylene ether) of claim 1, wherein each R¹ is methyl and each R² is hydrogen or methyl.

3. The crosslinked poly(arylene ether) of claim 1, wherein each R¹ is methyl and each R² is hydrogen.

4. A crosslinked poly(arylene ether), comprising
about 50 to about 99.8 weight percent of internal uncrosslinked units having the structure 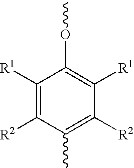
wherein each occurrence of R¹ is independently halogen, primary or secondary C₁-C₈ alkyl, phenyl, C₁-C₈ haloalkyl, C₁-C₈ aminoalkyl, C₁-C₈ hydrocarbonoxy, or C₂-C₈ halohydrocarbonoxy wherein at least two carbon atoms separate the halogen and oxygen atoms; and each occurrence of R² is independently hydrogen, halogen, primary or secondary C₁-C₈ alkyl, phenyl, C₁-C₈ haloalkyl, C₁-C₈ aminoalkyl, C₁-C₈ hydrocarbonoxy, or C₂-C₈ halohydrocarbonoxy wherein at least two carbon atoms separate the halogen and oxygen atoms, with the proviso that at least one occurrence of R² is hydrogen;
about 0.1 to about 10 weight percent of terminal uncrosslinked units having a structure selected from 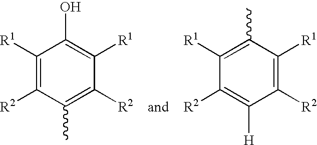
wherein each occurrence of R¹ is independently halogen, primary or secondary C₁-C₈ alkyl, phenyl, C₁-C₈ haloalkyl, C₁-C₈ aminoalkyl, C₁-C₈ hydrocarbonoxy, or C₂-C₈ halohydrocarbonoxy wherein at least two carbon atoms separate the halogen and oxygen atoms; and each occurrence of R² is independently hydrogen, halogen, primary or secondary C₁-C₈ alkyl, phenyl, C₁-C₈ haloalkyl, C₁-C₈ aminoalkyl, C₁-C₈ hydrocarbonoxy, or C₂-C₈ halohydrocarbonoxy wherein at least two carbon atoms separate the halogen and oxygen atoms, with the proviso that at least one occurrence of R² is hydrogen; and
about 0.1 to about 50 weight percent of crosslinked units having a structure selected from 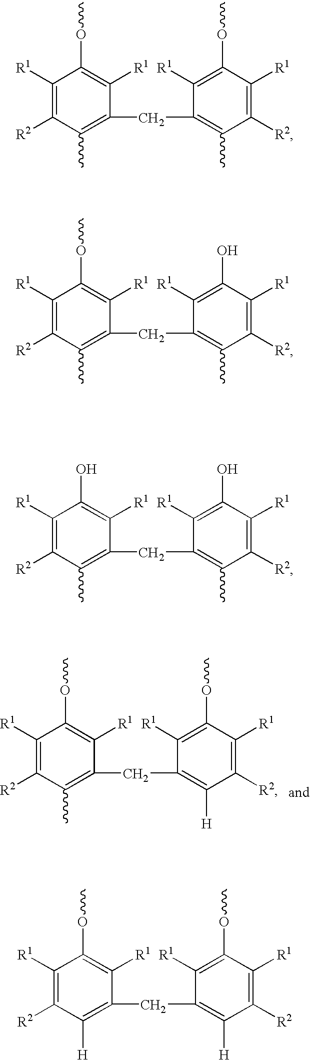
wherein each occurrence of R¹ is independently halogen, primary or secondary C₁-C₈ alkyl, phenyl, C₁-C₈ haloalkyl, C₁-C₈ aminoalkyl, C₁-C₈ hydrocarbonoxy, or C₂-C₈ halohydrocarbonoxy wherein at least two carbon atoms separate the halogen and oxygen atoms; and each occurrence of R² is independently hydrogen, halogen, primary or secondary C₁-C₈ alkyl, phenyl, C₁-C₈ haloalkyl, C₁-C₈ aminoalkyl, C₁-C₈ hydrocarbonoxy, or C₂-C₈ halohydrocarbonoxy wherein at least two carbon atoms separate the halogen and oxygen atoms.

5. A method of preparing a crosslinked poly(arylene ether), comprising:
reacting an uncrosslinked poly(arylene ether) with a formaldehyde compound in the presence of a catalytically effective amount of trifluoroacetic acid.

6. The method of claim 5, wherein the uncrosslinked poly(arylene ether) comprises a plurality of structural units of the formula 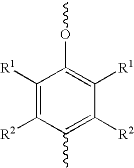
wherein each occurrence of R¹ is independently halogen, primary or secondary C₁-C₈ alkyl, phenyl, C₁-C₈ haloalkyl, C₁-C₈ aminoalkyl, C₁-C₈ hydrocarbonoxy, or C₂-C₈ halohydrocarbonoxy wherein at least two carbon atoms separate the halogen and oxygen atoms; and each occurrence of R² is independently hydrogen, halogen, primary or secondary C₁-C₈ alkyl, phenyl, C₁-C₈ haloalkyl, C₁-C₈ aminoalkyl, C₁-C₈ hydrocarbonoxy, or C₂-C₈ halohydrocarbonoxy wherein at least two carbon atoms separate the halogen and oxygen atoms, with the proviso that at least one occurrence of R² is hydrogen.

7. The method of claim 6, wherein each occurrence of R¹ is methyl, and each occurrence of R² is hydrogen or methyl.

8. The method of claim 5, wherein the uncrosslinked poly(arylene ether) has an intrinsic viscosity of about 0.05 to about 1.0 deciliter per gram at 25° C. in chloroform.

9. The method of claim 5, wherein the uncrosslinked poly(arylene ether) has an intrinsic viscosity of about 0.2 to about 0.6 deciliter per gram at 25° C. in chloroform.

10. The method of claim 5, wherein the formaldehyde compound is selected from formaldehyde, formaldehyde oligomers, and formaldehyde polymers.

11. The method of claim 5, wherein the formaldehyde compound comprises paraformaldehyde.

12. The method of claim 5, wherein the poly(arylene ether) and the formaldehyde compound are present in amounts such that a mole ratio of formaldehyde equivalents in the formaldehyde compound to arylene ether units in the uncrosslinked poly(arylene ether) is about 0.05 to about 2.

13. The method of claim 5, wherein the trifluoroacetic acid is present in an amount such that a mole ratio of trifluoroacetic acid to formaldehyde equivalents in the formaldehyde compound is about 0.1 to about 30.

14. The method of claim 5, wherein said reacting an uncrosslinked poly(arylene ether) with a formaldehyde compound is conducted in a solvent.

15. The method of claim 14, wherein the solvent is selected from dichloromethane, trichloromethane, tetrachloromethane, 1,2-dichloroethane, dichloroethylenes, trichloroethylene, toluene, benzene, xylenes, and combinations thereof.

16. The method of claim 5, wherein said reacting a poly(arylene ether) with a formaldehyde compound is conducted at a temperature of about 0 to about 140° C.

17. The method of claim 5, further comprising washing the crosslinked poly(arylene ether) with a solvent for the uncrosslinked poly(arylene ether).

18. The method of claim 5, further comprising washing the crosslinked poly(arylene ether) with an antisolvent for the uncrosslinked poly(arylene ether).

19. The method of claim 5, further comprising drying the crosslinked poly(arylene ether) at a temperature of about 50 to about 150° C. for about 5 minutes to about 2 days.

20. The method of claim 5, wherein said reacting an uncrosslinked poly(arylene ether) with a formaldehyde compound is conducted in the absence of a hydrohalic acid.

21. The method of claim 5, wherein said reacting an uncrosslinked poly(arylene ether) with a formaldehyde compound is conducted in the absence of a polymer other than the uncrosslinked poly(arylene ether).

22. A method of preparing a crosslinked poly(arylene ether), comprising:
reacting an uncrosslinked poly(arylene ether) with paraformaldehyde in the presence of a solvent and a catalytically effective amount of trifluoroacetic acid to form a crosslinked poly(arylene ether);
wherein the uncrosslinked poly(arylene ether) is a poly(2,6-dimethyl-1,4-phenylene ether) or a poly(2,6-dimethyl-1,4-phenylene ether-co-2,3,6-trimethyl-1,4-phenylene ether);
wherein the solvent is selected from chloroform or 1,2-dichloroethane;
wherein the poly(arylene ether) and the paraformaldehyde are present in amounts such that a mole ratio of formaldehyde equivalents in the paraformaldehyde to arylene ether units in the uncrosslinked poly(arylene ether) is about 0.1 to about 1; and
wherein the trifluoroacetic acid is present in an amount such that a mole ratio of trifluoroacetic acid to formaldehyde equivalents in the paraformaldehyde is about 0.5 to about 20;
washing the crosslinked poly(arylene ether) with an antisolvent for the uncrosslinked poly(arylene ether); and
drying the crosslinked poly(arylene ether) at about 65 to about 135° C. for about 20 minutes to about 1 day.

23. A crosslinked poly(arylene ether) prepared according to the method of claim 5.

24. The crosslinked poly(arylene ether) of claim 23, exhibiting a glass transition temperature of about 170 to about 290° C.

25. The crosslinked poly(arylene ether) of claim 23, exhibiting a chloroform solubility at 25° C. of about 0.1 to about 20 milligrams per milliliter.

26. A crosslinked poly(arylene ether) prepared according to the method of claim 22.

27. A composition comprising the crosslinked poly(arylene ether) of claim 1.

28. The composition of claim 27, comprising at least 50 weight percent of the crosslinked poly(arylene ether)

29. The composition of claim 27, further comprising a poly(alkenyl aromatic) resin, a poly(dimethylsiloxane), or a combination thereof.

30. The composition of claim 27, further comprising an additive selected from flame retardants, colorants, fillers, polymeric additives, and mixtures thereof.

31. A composition comprising the crosslinked poly(arylene ether) of claim 23.

32. A composition comprising the crosslinked poly(arylene ether) of claim 26.

33. An article comprising the composition of claim 27.

34. An article comprising the composition of claim 31.

35. An article comprising the composition of claim 32.
